(19) United States
(12) Patent Application Publication
(10) Pub. No.: US 2014/0055357 A1
(43) Pub. Date: Feb. 27, 2014

(54) AUTOMATIC TOUCHPAD TURN-OFF IN A COMPUTING DEVICE

(71) Applicant: Dhaval Dave, Ahmedabad (IN)

(72) Inventor: Dhaval Dave, Ahmedabad (IN)

(73) Assignee: NVIDIA Corporation, Santa Clara, CA (US)

(21) Appl. No.: 13/590,208

(22) Filed: Aug. 21, 2012

(51) Int. Cl. G06F 3/041

(52) U.S. Cl. 345/168

(57) ABSTRACT

A method includes sensing data related to a presence of at least a portion of a hand of a user of a computing device when the user is typing using a keyboard or a keypad of the computing device located proximate a touchpad thereof through one or more sensor(s) communicatively coupled to a processor of the computing device and located proximate both the keyboard or the keypad and the touchpad, and transmitting the sensed data to the processor. The method also includes automatically turning off the touchpad through a driver component thereof when the processor determines the presence of at least the portion of the hand of the user when the user is typing using the keyboard or the keypad based on the received sensed data.

### FIELD OF TECHNOLOGY

This disclosure relates generally to computing devices and, more particularly, to automatic touchpad turn-off in a computing device.

### BACKGROUND

A computing device such as a laptop computer or a notebook computer may have a keyboard or a keypad and a touchpad proximate each other. When a user of the computing device types using the keyboard or the keypad, a palm portion of a hand of the user may come into contact with the touchpad. The aforementioned contact may cause an uncontrolled movement of a pointer on a screen of a display unit of the computing device. The aforementioned contact may also cause undesirable clicks on objects on the screen that may even trigger events such as a shutdown of computing device 100, thereby potentially causing loss of user data.

### SUMMARY

Disclosed are a method, an apparatus and/or a system of automatic touchpad turn-off in a computing device.

In one aspect, a method includes sensing data related to a presence of at least a portion of a hand of a user of a computing device when the user is typing using a keyboard or a keypad of the computing device located proximate a touchpad thereof through one or more sensor(s) communicatively coupled to a processor of the computing device and located proximate both the keyboard or the keypad and the touchpad, and transmitting the sensed data to the processor. The method also includes automatically turning off the touchpad through a driver component thereof when the processor determines the presence of at least the portion of the hand of the user when the user is typing using the keyboard or the keypad based on the received sensed data.

In another aspect, a computing device includes a processor, a memory including storage locations configured to be addressable through the processor, and a touchpad. The computing device also includes a keyboard or a keypad located proximate the touchpad, and one or more sensor(s) located proximate both the keyboard or the keypad and the touchpad. The one or more sensor(s) is communicatively coupled to the processor and is configured to sense data related to a presence of at least a portion of a hand of a user of the computing device when the user is typing using the keyboard or the keypad. The one or more sensor(s) is also configured to transmit the sensed data to the processor.

Further, the computing device includes a driver component of the touchpad to automatically turn off the touchpad when the processor determines the presence of at least the portion of the hand of the user when the user is typing using the keyboard or the keypad based on the received sensed data.

In yet another aspect, a non-transitory medium, readable through a computing device and including instructions embodied therein that are executable through the computing device is disclosed. The non-transitory medium includes instructions to sense data related to a presence of at least a portion of a hand of a user of the computing device when the user is typing using a keyboard or a keypad of the computing device located proximate a touchpad thereof through one or more sensor(s) communicatively coupled to a processor of the computing device and located proximate both the keyboard or the keypad and the touchpad.

The non-transitory medium also includes instructions to transmit the sensed data to the processor, and instructions to automatically turn off the touchpad through a driver component thereof when the processor determines the presence of at least the portion of the hand of the user when the user is typing using the keyboard or the keypad based on the received sensed data.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a computing device, according to one or more embodiments.

FIG. 2 is an illustrative view of a laptop computer as an example computing device of FIG. 1, along with two sensors along a plane of a keyboard.

FIG. 3 is a schematic view of interaction between a touchpad driver component and a touchpad of the computing device of FIG. 1.

FIG. 4 is an illustrative view of an example scenario of pattern detection through the sensors of FIG. 2.

FIG. 5 is a schematic view of interaction between a keyboard driver component and a keyboard, according to one or more embodiments.

FIG. 6 is a process flow diagram detailing the operations involved in automatically turning off a touchpad of the computing device of FIGS. 1-2, according to one or more embodiments.

Other features of the present embodiments will be apparent from the accompanying drawings and from the detailed description that follows.

### DETAILED DESCRIPTION

Example embodiments, as described below, may be used to provide a method, an apparatus and/or a system of automatic touchpad turn-off in a computing device. Although the present embodiments have been described with reference to specific example embodiments, it will be evident that various modifications and changes may be made to these embodiments without departing from the broader spirit and scope of the various embodiments.

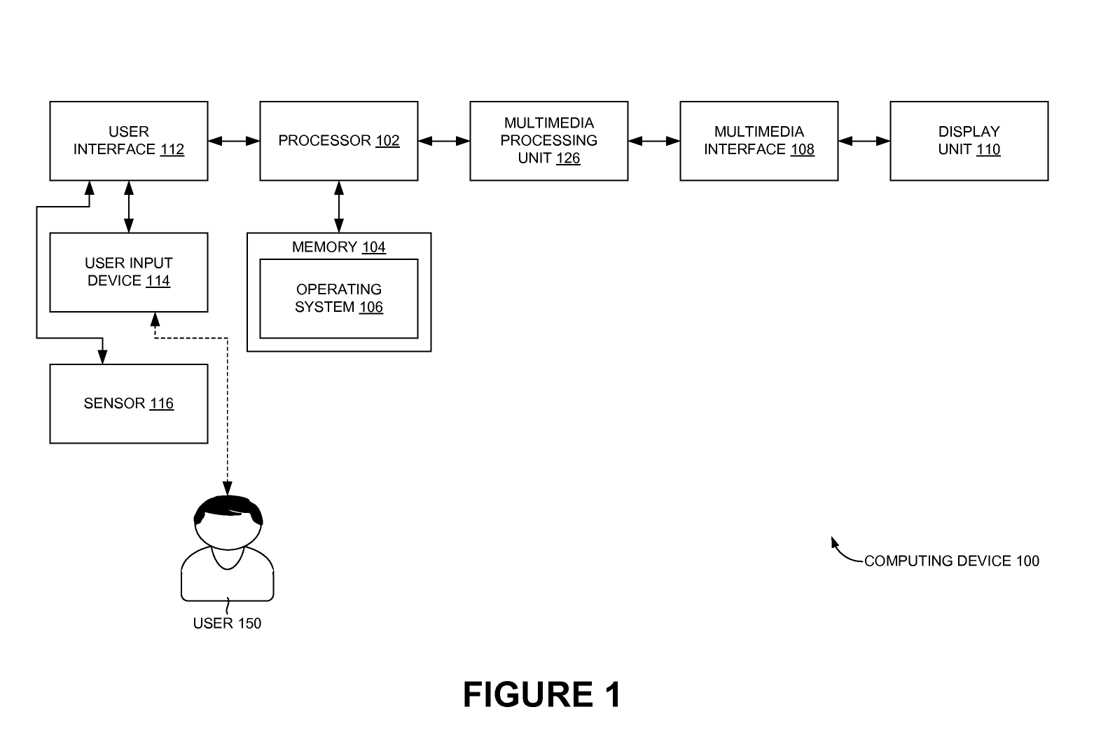

FIG. 1 shows a computing device 100, according to one or more embodiments. An example computing device 100 may include but is not limited to a desktop computer, a laptop computer, a notebook computer, a tablet and a mobile device such as a mobile phone. In one or more embodiments, computing device 100 may include a processor 102 (e.g., Central Processing Unit (CPU), Graphics Processing Unit (GPU)) communicatively coupled to a memory 104, processor 102 being configured to address storage locations in memory 104. In one or more embodiments, memory 104 may include a volatile memory (e.g., Random Access Memory (RAM)) and/or a non-volatile memory (e.g., Read-Only Memory (ROM), hard disk).

In one or more embodiments, output data associated with processing through processor 102 may be input to a multimedia processing unit 126 configured to perform encoding/decoding associated with the data. In one or more embodiments, the output of multimedia processing unit 126 may be rendered on a display unit 110 (e.g., Liquid Crystal Display (LCD) display, Cathode Ray Tube (CRT) monitor) through a multimedia interface 108 configured to convert data to an appropriate format required by display unit 110.

It is obvious that an operating system 106 may execute on computing device 100. FIG. 1 shows operating system 106 as being stored in memory 104 (e.g., non-volatile memory). In one or more embodiments, a user interface 112 (e.g., a Universal Serial Bus (USB) port) interfaced with processor 102 may be provided in computing device 100 to enable coupling of a user input device 114 to processor 102 therethrough. In one or more embodiments, user input device 114 may include a keyboard/keypad and/or a pointing device (e.g., mouse, touchpad). In one or more embodiments involving a computing device 100 such as a laptop or a notebook, a touchpad may be provided in proximity to a keyboard/keypad on a plane utilized for user input.

A user 150 of a laptop or a notebook may be accidentally making contact with the touchpad while utilizing the keyboard/keypad to type. The aforementioned contact may cause a pointer (or, a cursor) on display unit 110 configured to move in accordance with movement of the touchpad to follow the movement associated with the contact that is beyond the control of user 150. Occasionally, the movement of the pointer may cause accidental clicks on the screen of display unit 110.

In order to avoid the abovementioned occurrences, computing device 100 may include one or more sensor(s) (e.g., FIG. 1 shows one sensor 116 merely for illustrative purposes) to detect the presence of one or both hand(s) of user 150 while user 150 is typing using the keypad/keyboard. More than one type of sensor 116 may be utilized to detect the presence of the hand(s) of user 150. Examples of sensor 116 include but are not limited to a light sensor and an antenna. Other example sensors (e.g., sensor 116) to detect the presence of the hand(s) of user 150 are within the scope of the exemplary embodiments.

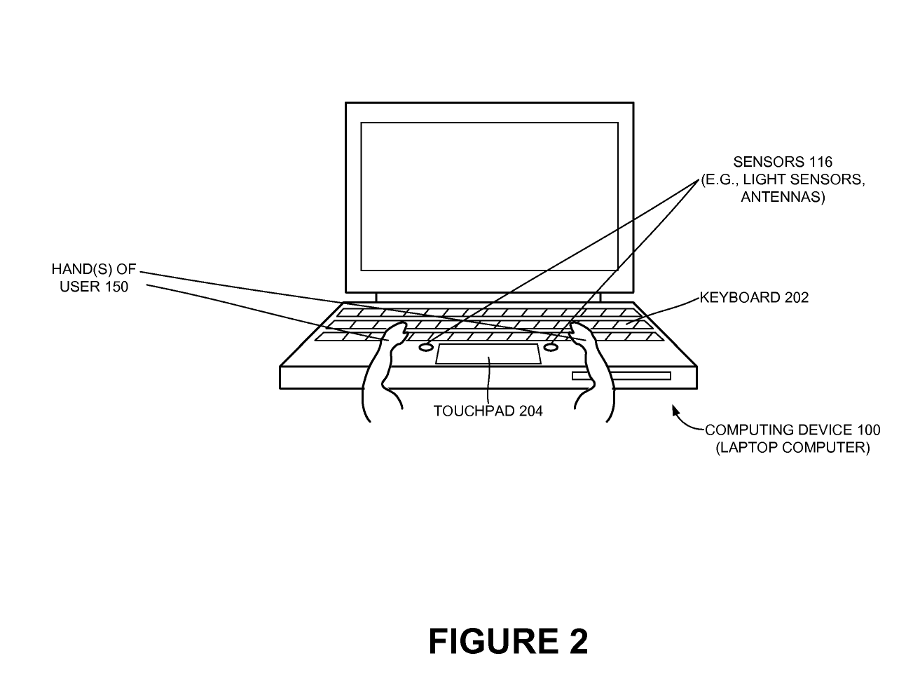

In one or more embodiments, sensor 116 may be coupled to processor 102 by way of user interface 112 (e.g., user interface 112 may include a sensor interface). FIG. 2 shows a laptop computer as an example computing device 100, along with two sensors 116 along a plane of a keyboard 202 for illustrative purposes. Keyboard 202 is shown as being proximate touchpad 204. The two sensors 116 are shown as being located approximately midway between keyboard 202 and touchpad 204. When user 150 is busy typing on keyboard 202, one or more of the two sensors 116 may detect the presence of a hand (e.g., palm portion) of user 150 and may initiate turning off of touchpad 204 through a driver component (e.g., software driver) of touchpad 204. When sensors 116 fail to detect the hand(s) of user 150, processor 102 may initiate the turning on of touchpad 204 through the driver component of touchpad 204.

As discussed above, each of sensors 116 may be a light sensor or an antenna. Light sensor(s) and antenna(s) are well-known to one of ordinary skill in the art and, therefore, detailed discussion associated therewith is skipped for the sake of convenience and brevity. It is obvious that a light sensor may be sensing an ambient light of the laptop computer and that data associated with the sensing may change when a hand of user 150 blocks at least a portion of the ambient light, which triggers the turning off of touchpad 204 discussed above. In the case of an antenna, the antenna may be transmitting a radiation having particular characteristics that may change when a hand of user 150 is proximate thereto, which, again, triggers the turning off of touchpad 204 discussed above. Alternately, each of two antennas (example sensors 116) may have a radiation transmission therebetween that is disturbed due to the presence of a hand of user 150 proximate thereto, which, once again, triggers the turning off of touchpad 204 discussed above.

It is obvious that the abovementioned sensing techniques with regard to light sensor(s) and antenna(s) merely serve as examples and that other techniques are within the scope of the exemplary embodiments. Further, as mentioned above, other forms of sensors are also within the scope of the exemplary embodiments.

FIG. 2 shows two sensors 116 merely for illustrative purposes. It is obvious that merely one sensor 116 or more than two sensors 116 may be employed for the sensing. Also, the position and location of sensors 116 should not be construed as limiting. For example, a single sensor 116 placed midway along the plane of keyboard 202 and touchpad 204 may suffice.

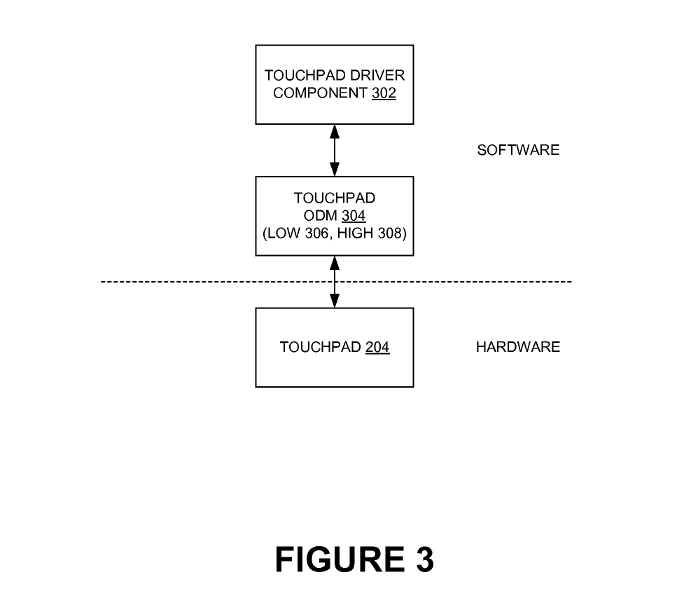

FIG. 3 shows interaction between a touchpad driver component 302 and touchpad 204 during turning on/off of touchpad 204. In one or more embodiments, an Original Design Manufacturer (ODM) associated with computing device 100, keyboard 202 (or, keypad as the case may be) and/or touchpad 204 may define intensity levels relevant to the turning on/off of touchpad 204 (e.g., shown as touchpad ODM 304). For example, two intensity levels may be defined by the ODM, viz., low 306 and high 308.

In an example embodiment, an intensity level of high 308 may signify the on state of touchpad 204. Whenever user 150 is typing using keyboard 202, sensor 116 may detect the presence of the hand(s) thereof and processor 102 may enable touchpad driver component 302 initiate the transitioning of the state of touchpad 204 into low 306, which turns off touchpad 204. Now, when sensor 116 does not detect the presence of the hand(s) of user 150, the state of touchpad 204 may, again, be transitioned into high 308 (e.g., again, processor 102 may enable touchpad driver component 302 to cause the transition), which turns on touchpad 204.

It is obvious that sensor 116 may be commercially available integrated into the plane of keyboard 202/touchpad 204. In one or more embodiments, the output of sensor 116 may be regarded by processor 102 as being analogous to the input from keyboard 202 (or, keypad)/touchpad 204.

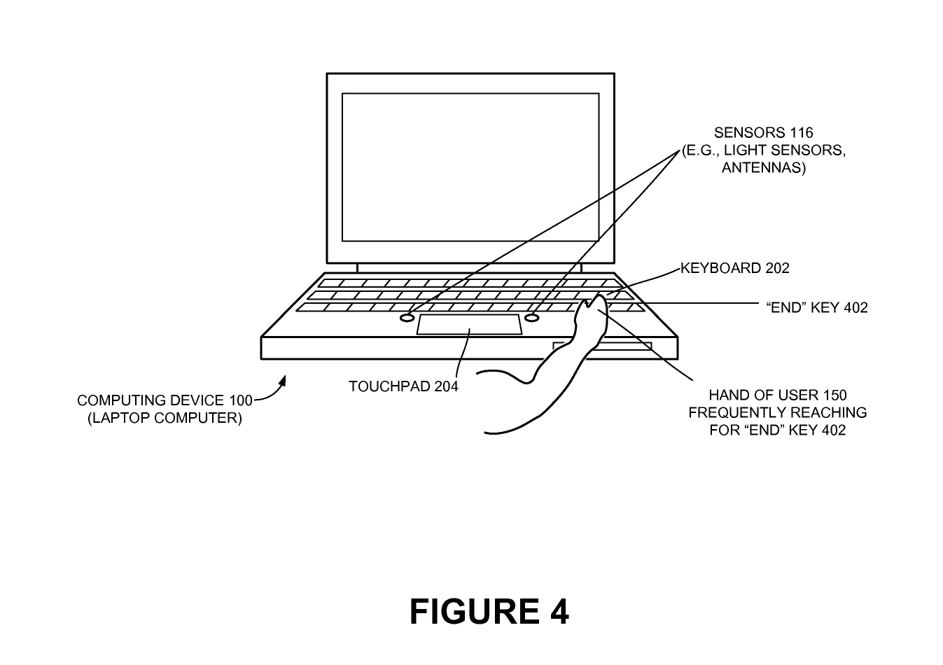

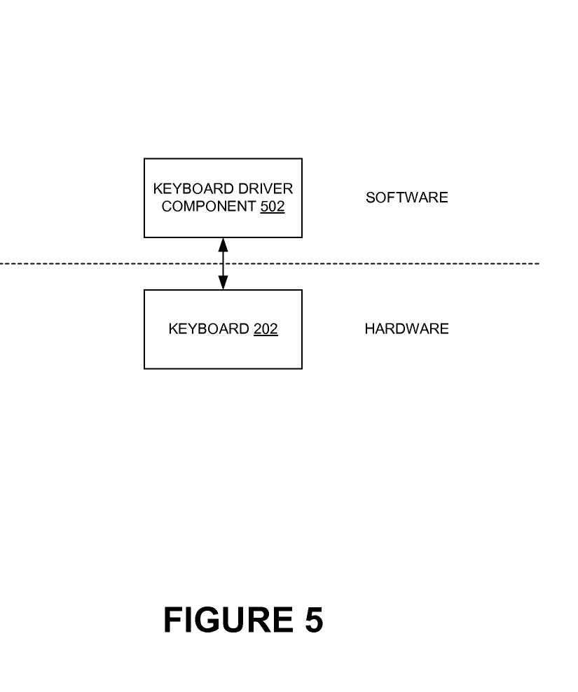

In one example embodiment, the setup of sensors 116 in FIG. 2 may additionally be utilized for pattern detection based on keyboard 202 “behavior” on part of user 150. FIG. 4 shows an example scenario of pattern detection through sensors 116 of FIG. 2. For example, keyboard 202 may have an “End” key 402 on one side (e.g., right side of user 150) thereof. User 150 may frequently be using the aforementioned “End” key 402 for his/her work. The one of the two sensors 116 most proximate “End” key 402 may detect the hand of user 150 whenever user 150 utilizes “End” key 402, and may frequently transmit data at a same appropriate level corresponding to “End” key 402 to processor 102, which, in turn, may detect the frequency of use of “End” key 402 based on analysis of the data received thereat. Processor 102 may enable a keyboard driver component 502 (see FIG. 5) to automatically dispense with a requirement of user 150 to depress “End” key 402 by way of enabling automatic performance of a function associated with “End” key 402 whenever user 150 moves his/her hand toward “End” key 402.

FIG. 5 shows interaction between a keyboard driver component 502 and keyboard 202. When processor 102 detects the frequency of use of “End” key 402 by user 150, processor 102 may automatically initiate keyboard driver component 502 to perform the same function as user 150 depressing “End” key 402. Thus, the functionality associated with user 150 depressing “End” key 402 may be automated. It is obvious that other forms of key substitution and pattern detection may be envisioned.

In another example scenario, pattern detection may involve user 150 moving his/her hand over one or more sensors 116. The aforementioned movement of the hand over the two sensors 116 of FIG. 2, for example, may be interpreted by processor 102 as a gesture on part of user 150 based on a predefined pattern to initiate execution of an application on computing device 100. The aforementioned form of pattern detection is also within the scope of the exemplary embodiments.

Thus, as discussed above, exemplary embodiments may serve to enable automatic turning off of touchpad 204 that avoids erroneous on-screen clicks on display unit 110. In one or more embodiments, computing device 100 may provide an option (e.g., through a button) to user 150 to enable/disable the aforementioned automatic turning off/on of touchpad 204. For example, upon disabling the option, processor 102 may trigger switching off of sensor 116 or may bypass analysis of data received therefrom. In one or more embodiments, in the case of there being more than one sensor 116, computing device 100 may provide an option to user 150 to disable one or more sensors 116 (e.g., merely one sensor 116, all sensors 116).

In one or more embodiments, touchpad 204 may have a right-click button and a left-click button. It is obvious that the aforementioned buttons of touchpad 204 may also be disabled in accordance with sensing at least some portion of the hand of user 150. In one or more alternate embodiments, options may be provided to user 150 to solely disable buttons of touchpad 204 and not the other capabilities of touchpad 204 or maintain the buttons in an active state and disable the other capabilities of touchpad 204.

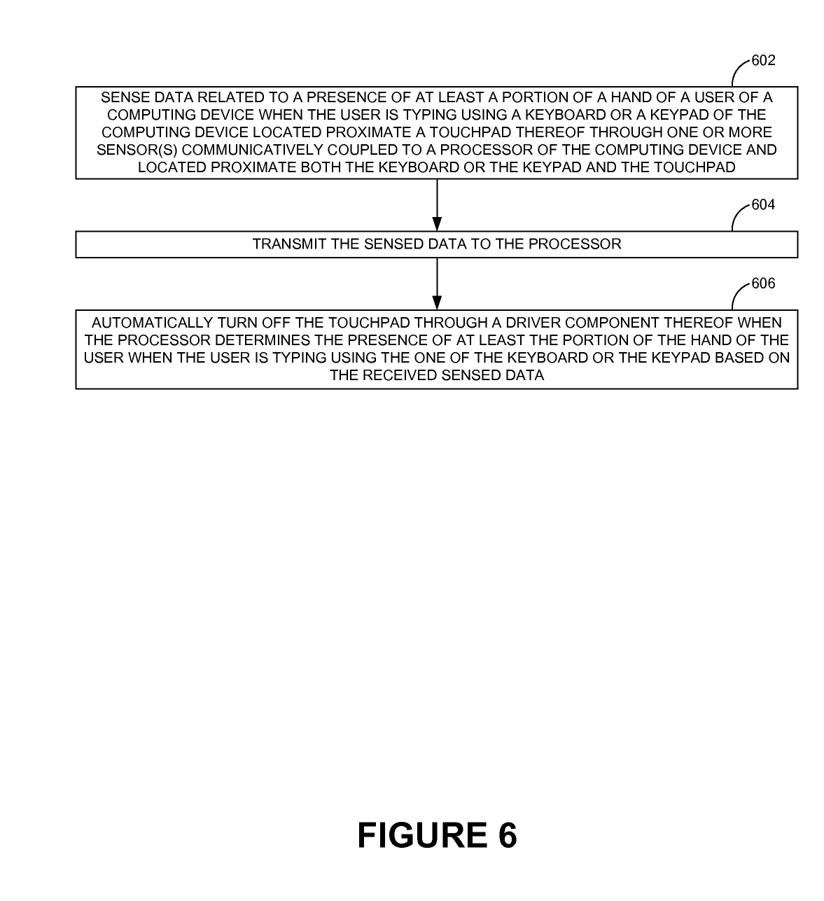

FIG. 6 shows a process flow diagram detailing the operations involved in a method of automatically turning off touchpad 204 of computing device 100, according to one or more embodiments. In one or more embodiments, operation 602 may involve sensing data related to a presence of at least a portion of a hand of user 150 of computing device 100 when user 150 is typing using keyboard 202 (or, a keypad) of computing device 100 located proximate touchpad 204 through one or more sensor(s) (e.g., sensor 116) communicatively coupled to processor 102 of computing device 100 and located proximate both keyboard 202 (or, the keypad) and touchpad 204. In one or more embodiments, operation 604 may involve transmitting the sensed data to processor 102.

In one or more embodiments, operation 606 may then involve automatically turning off touchpad 204 through a driver component (e.g., touchpad driver component 302) thereof when processor 102 determines the presence of at least the portion of the hand of user 150 when user 150 is typing using keyboard 202 (or, the keypad) based on the received sensed data.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a non-transitory machine-readable medium). For example, the various electrical structure and methods may be embodied using transistors, logic gates, and electrical circuits (e.g., Application Specific Integrated Circuitry (ASIC) and/or Digital Signal Processor (DSP) circuitry).

In addition, it will be appreciated that the various operations, processes, and methods disclosed herein may be embodied in a non-transitory machine-readable medium and/or a machine accessible medium compatible with a data processing system (e.g., computer device 100), and may be performed in any order (e.g., including using means for achieving the various operations). Various operations discussed above may be tangibly embodied on a non-transitory machine-readable medium readable through computing device 100 to perform functions through operations on input and generation of output. These input and output operations may be performed by a processor (e.g., processor 102). The non-transitory machine-readable medium readable through computing device 100 may be, for example, a memory, a transportable medium such as a Compact Disc (CD), a Digital Video Disc (DVD), a Blu-ray™ disc, a floppy disk, or a diskette.

The non-transitory machine-readable medium may include instructions embodied therein that are executable on computing device 100. A computer program embodying the aspects of the exemplary embodiments may be loaded onto computing device 100. The computer program is not limited to specific embodiments discussed above, and may, for example, be implemented in an operating system, an application program, a foreground or a background process, a driver, a network stack or any combination thereof. For example, software associated with sensor 116 may be available on the non-transitory machine-readable medium readable through computing device 100. The computer program may be executed on a single computer processor or multiple computer processors.

Accordingly, the specification and drawings are to be regarded in an illustrative rather than a restrictive sense.

What is claimed is:

1. A method comprising:
sensing data related to a presence of at least a portion of a hand of a user of a computing device when the user is typing using one of a keyboard and a keypad of the computing device located proximate a touchpad thereof through at least one sensor communicatively coupled to a processor of the computing device and located proximate both the one of the keyboard and the keypad and the touchpad;
transmitting the sensed data to the processor; and
automatically turning off the touchpad through a driver component thereof when the processor determines the presence of at least the portion of the hand of the user when the user is typing using the one of the keyboard and the keypad based on the received sensed data.

2. The method of claim 1, further comprising automatically turning on the touchpad through the driver component when the processor is unable to determine the presence of at least the portion of the hand of the user.

3. The method of claim 1, wherein the at least one sensor is at least one of at least one light sensor and at least one antenna.

4. The method of claim 3, wherein when there is a plurality of antennas as the at least one sensor, the method comprises detecting the presence of at least the portion of the hand of the user when a characteristic of radiation transmitted between the plurality of antennas is disturbed.

5. The method of claim 1, where automatically turning off the touchpad through the driver component thereof further comprises:
transitioning from a state of high intensity level of the touchpad into a state of low intensity level thereof through the driver component, the high intensity level and the low intensity level being defined through an Original Design Manufacturer (ODM) of at least one of the computing device, the one of the keyboard and the keypad, and the touchpad.

6. The method of claim 3, wherein when there is a plurality of sensors, the method further comprises at least one of:
detecting a pattern of use of the one of the keyboard and the keypad on part of the user utilizing the plurality of sensors in conjunction with the processor to enable automatic performance of a function of a key through a driver component of the one of the keyboard and the keypad; and
detecting a predefined pattern based on a movement of the hand of the user utilizing the plurality of sensors in conjunction with the processor to enable automatic execution of an application on the computing device.

7. The method of claim 1, further comprising providing an option to the user to one of:
enable and disable the automatic turning off of the touchpad.

8. A computing device comprising:
a processor;
a memory including storage locations configured to be addressable through the processor;
a touchpad;
one of a keyboard and a keypad located proximate the touchpad;
at least one sensor located proximate both the one of the keyboard and the keypad and the touchpad, the at least one sensor being communicatively coupled to the processor and being configured to: sense data related to a presence of at least a portion of a hand of a user of the computing device when the user is typing using the one of the keyboard and the keypad, and transmit the sensed data to the processor; and
a driver component of the touchpad to automatically turn off the touchpad when the processor determines the presence of at least the portion of the hand of the user when the user is typing using the one of the keyboard and the keypad based on the received sensed data.

9. The computing device of claim 8, wherein the driver component of the touchpad is configured to automatically turn on the touchpad when the processor is unable to determine the presence of at least the portion of the hand of the user.

10. The computing device of claim 8, wherein the at least one sensor is at least one of at least one light sensor and at least one antenna.

11. The computing device of claim 10, wherein when there is a plurality of antennas as the at least one sensor, the processor is configured to detect the presence of at least the portion of the hand of the user based on a characteristic of radiation transmitted between the plurality of antennas being disturbed.

12. The computing device of claim 8, wherein the driver component of the touchpad is configured to automatically turn off the touchpad based on transitioning from a state of high intensity level of the touchpad into a state of low intensity level thereof, the high intensity level and the low intensity level being defined through an Original Design Manufacturer (ODM) of at least one of the computing device, the one of the keyboard and the keypad, and the touchpad.

13. The computing device of claim 10, wherein at least one of:
the computing device further comprises a driver component of the one of the keyboard and the keypad,
wherein when there is a plurality of sensors, the processor is further configured to detect a pattern of use of the one of the keyboard and the keypad on part of the user utilizing the plurality of sensors to enable automatic performance of a function of a key through a driver component of the one of the keyboard and the keypad, and
the plurality of sensors in conjunction with the processor is configured to detect a predefined pattern based on a movement of the hand of the user to enable automatic execution of an application on the computing device.

14. The computing device of claim 8, wherein the computing device is one of a laptop computer, a notebook computer and a mobile device.

15. A non-transitory medium, readable through a computing device and including instructions embodied therein that are executable through the computing device, comprising:
instructions to sense data related to a presence of at least a portion of a hand of a user of the computing device when the user is typing using one of a keyboard and a keypad of the computing device located proximate a touchpad thereof through at least one sensor communicatively coupled to a processor of the computing device and located proximate both the one of the keyboard and the keypad and the touchpad;
instructions to transmit the sensed data to the processor; and
instructions to automatically turn off the touchpad through a driver component thereof when the processor determines the presence of at least the portion of the hand of the user when the user is typing using the one of the keyboard and the keypad based on the received sensed data.

16. The non-transitory medium of claim 15, further comprising instructions to automatically turn on the touchpad through the driver component when the processor is unable to determine the presence of at least the portion of the hand of the user.

17. The non-transitory medium of claim 15, comprising instructions to sense the data related to the presence of at least the portion of the hand of the user through one of at least one light sensor and at least one antenna.

18. The non-transitory medium of claim 17, wherein when there is a plurality of antennas as the at least one sensor, the non-transitory medium comprises instructions to detect the presence of at least the portion of the hand of the user when a characteristic of radiation transmitted between the plurality of antennas is disturbed.

19. The non-transitory medium of claim 15, where the non-transitory medium comprises instructions to automatically turn off the touchpad through the driver component thereof in accordance with transitioning from a state of high intensity level of the touchpad into a state of low intensity level thereof through the driver component, the high intensity level and the low intensity level being defined through an Original Design Manufacturer (ODM) of at least one of the computing device, the one of the keyboard and the keypad, and the touchpad.

20. The non-transitory medium of claim 17, wherein when there is a plurality of sensors, the non-transitory medium further comprises at least one of:
instructions to detect a pattern of use of the one of the keyboard and the keypad on part of the user utilizing the plurality of sensors in conjunction with the processor to enable automatic performance of a function of a key through a driver component of the one of the keyboard and the keypad; and
instructions to detect a predefined pattern based on a movement of the hand of the user utilizing the plurality of sensors in conjunction with the processor to enable automatic execution of an application on the computing device.
